(19) United States
(12) Patent Application Publication
(10) Pub. No.: US 2023/0381941 A1
(43) Pub. Date: Nov. 30, 2023

(54) COLLET BIT RETAINER

(71) Applicant: MILWAUKEE ELECTRIC TOOL CORPORATION, Brookfield, WI (US)

(72) Inventors: Kentez L. Craig, Milwaukee, WI (US); Devin C. Albrecht, Mequon, WI (US); Ian A. Duncan, Colgate, WI (US); Terry L. Timmons, Oconomowoc, WI (US)

(21) Appl. No.: 18/202,038

(22) Filed: May 25, 2023

Related U.S. Application Data
(60) Provisional application No. 63/345,686, filed on May 25, 2022.

(51) Int. Cl. B25F 5/00

(52) U.S. Cl. CPC B25F 5/00

(57) ABSTRACT

A bit retainer is configured to couple a tool bit to an output spindle of a power tool. The bit retainer includes a body coupled for co-rotation with the output spindle about a rotational axis, a collet including a plurality of jaws positioned at least partially within the body, the collet defining a bore between the plurality of jaws configured to receive the tool bit, a wedge surface engageable with the collet, and a sleeve surrounding the body. The sleeve is movable relative to the body to engage the wedge surface against the collet and compress the plurality of jaws around the tool bit.

### CROSS-REFERENCE TO RELATED APPLICATIONS

The present application claims priority to U.S. Provisional Patent Application No. 63/345,686, filed May 25, 2022, the entire content of which is incorporated herein by reference.

### FIELD

The present disclosure relates to power tools, and, more particularly, to bit retainers for power tools.

### BACKGROUND

Power tools, and particularly rotary power tools such as impact drivers, impact wrenches, drills, powered screwdrivers, etc., typically include a bit retainer. Adjustable three-jaw chucks are commonly used on drills to clamp and retain tool bits with both round and non-round (e.g., hex, square, etc.) shank geometries. Such chucks may be relatively heavy, long, and may take time and several rotations to change and clamp different tool bits. Quick-release bit retainers are commonly used with impact drivers and powered screwdrivers to retain non-round shank geometries. Quick-release bit retainers are typically compact and facilitate efficiently swapping tool bits, but such bit retainers only accept one shank size and may have greater runout than three-jaw chucks.

### SUMMARY

One aspect of the disclosure provides a bit retainer configured to couple a tool bit to an output spindle of a power tool. The bit retainer includes a body coupled for co-rotation with the output spindle about a rotational axis, a collet including a plurality of jaws positioned at least partially within the body, the collet defining a bore between the plurality of jaws configured to receive the tool bit, a wedge surface engageable with the collet, and a sleeve surrounding the body. The sleeve is movable relative to the body to engage the wedge surface against the collet and compress the plurality of jaws around the tool bit.

Another aspect of the disclosure provides a bit retainer configured to couple a tool bit to an output spindle of a power tool. The bit retainer includes a body coupled for co-rotation with the output spindle about a rotational axis, a standardized collet including a plurality of jaws positioned at least partially within the body, the collet defining a bore between the plurality of jaws configured to receive the tool bit, and a sleeve surrounding the body. The sleeve is movable relative to the body to compress the plurality of jaws around the tool bit.

Another aspect of the disclosure provides a power tool including a housing, a motor supported within the housing, an output spindle extending from the housing and driven by the motor to rotate about a rotational axis, and a bit retainer configured to couple a tool bit to the output spindle such that the tool bit co-rotates with the output spindle about the rotational axis. The bit retainer includes a body coupled for co-rotation with the output spindle, a collet including a plurality of jaws positioned at least partially within the body, the collet defining a bore between the plurality of jaws configured to receive the tool bit, a wedge surface engageable with the collet, and a sleeve surrounding the body. The sleeve is movable relative to the body to engage the wedge surface against the collet and compress the plurality of jaws around the tool bit.

Other aspects of the disclosure will become apparent by consideration of the detailed description and accompanying drawings.

### BRIEF DESCRIPTION OF THE DRAWINGS

FIG. 1 is a perspective view of an exemplary power tool in which bit retainers embodying aspects of the present disclosure may be implemented.

FIG. 2 is a cross-sectional view of the power tool of FIG. 1, taken along line A—A in FIG. 1.

FIG. 3 is an enlarged cross-sectional view of a portion of the power tool illustrated in FIG. 2.

FIG. 4A is a cross-sectional perspective view of a bit retainer, according to an embodiment of the present disclosure.

FIG. 4B is a front perspective view of the bit retainer of FIG. 4A.

FIG. 5 is a perspective view of a jaw arrangement of the bit retainer of FIG. 4A.

FIG. 6A is a cross-sectional view of the bit retainer of the FIG. 4A, taken along line 6A-6A in FIG. 4A.

FIG. 6B is a cross-sectional view of the bit retainer of the FIG. 4A, taken along line 6B-6B in FIG. 4A.

FIG. 6C is a cross-sectional perspective view of the bit retainer of FIG. 4A including an alternate jaw arrangement.

FIG. 6D is a cross-sectional view of the bit retainer of the FIG. 6C, taken along representative line 6D-6D in FIG. 4A.

FIG. 6E is a perspective view of the alternate jaw arrangement of FIG. 6C.

FIG. 7A is a perspective view of a bit retainer according to another embodiment of the present disclosure.

FIG. 7B is a partially exploded perspective view of the bit retainer of FIG. 7A.

FIG. 8A is a cross-sectional perspective view of the bit retainer of FIG. 7A, taken along line 8A-8A in FIG. 7A.

FIG. 8B is a cross-sectional perspective view of the bit retainer of FIG. 7A, taken along line 8B-8B in FIG. 7A.

FIG. 9A is a perspective view of a bit retainer according to another embodiment of the present disclosure.

FIG. 9B is a perspective view of the bit retainer of FIG. 9A with some elements hidden.

FIG. 9C is a perspective view of a spring of the bit retainer of FIG. 9A.

FIG. 10A is a cross-sectional perspective view of the bit retainer of FIG. 9A, taken along line 10A-10A in FIG. 9A.

FIG. 10B is a cross-sectional perspective view of the bit retainer of FIG. 9A, taken along line 10B-10B in FIG. 9A.

FIG. 11A is a cross-sectional view of a bit retainer according to another embodiment of the present disclosure.

FIG. 11B is another cross-sectional view of the bit retainer of FIG. 11A, with the section plane rotated by 90 degrees relative to the orientation of FIG. 11A.

FIG. 12A is a perspective view of a bit retainer according to another embodiment of the present disclosure.

FIG. 12B is an exploded perspective view of the bit retainer of FIG. 12A.

FIG. 13A is a cross-sectional view of the bit retainer of FIG. 12A taken along line 13A-13A in FIG. 12A.

FIG. 13B is a cross-sectional view of the bit retainer of FIG. 12A taken along line 13B-13B in FIG. 12A.

FIG. 13C is another cross-sectional view of the bit retainer of FIG. 12A taken along line 13A-13A in FIG. 12A, with elements of the bit retainer hidden.

FIG. 14 is a cross-sectional view of a bit retainer according to another embodiment of the present disclosure.

FIG. 15 is a perspective view of an anvil, which may be implemented with a bit retainer embodying aspects of the present disclosure.

FIG. 16 is a perspective view of a bit retainer according to another embodiment of the present disclosure.

FIG. 17 is an exploded perspective view of the bit retainer of FIG. 16.

FIG. 18 is a cross-sectional view of the bit retainer of FIG. 16, taken along line 18-18 in FIG. 16.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

The present disclosure provides, among other things, embodiments of a bit retainer for a power tool, which include a collet coupled to or formed as a part of an output spindle of the power tool. In some embodiments, the collet includes a plurality of jaws that press against a tool bit to retain the end of the tool bit within the collet. The embodiments described and illustrated herein may advantageously provide reduced runout, or wobbling of the tool bit, while still maintaining quick-change functionality and, in some embodiments, without increasing the overall length of the tool. For example, bit retainer embodiments described and illustrated herein may provide an approximately 80% reduction in runout relative to a conventional quick-change bit retainer (e.g., a standard impact driver hex shank bit retainer). In some embodiments, the bit retainers may advantageously accept both hexagonal shank and round shank bits. The adjustable nature of the collet may also allow a wider range of bits to be used, and the collet may be interchanged with standard collets of various sizes in some embodiments.

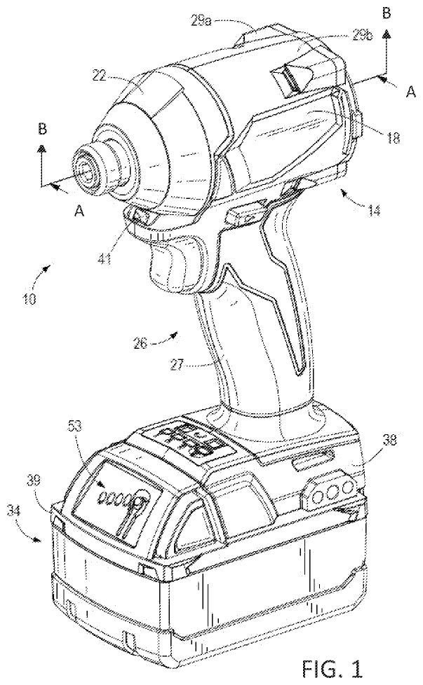

FIG. 1 illustrates an exemplary power tool 10 in the form of an impact driver. The illustrated power tool 10 includes a housing 14 with a motor housing portion 18, a front housing portion or gear case 22 coupled to the motor housing portion 18 (e.g., by a plurality of fasteners), and a handle portion 26 disposed underneath the motor housing portion 18. The handle portion 26 includes a grip 27 that can be grasped by a user operating the power tool 10. In the illustrated embodiment, the handle portion 26 and the motor housing portion 18 are defined by cooperating clamshell halves 29a, 29b. In some embodiments, the clamshell halves 29a, 29b may also define at least a portion (e.g., a rear portion) of the gear case 22.

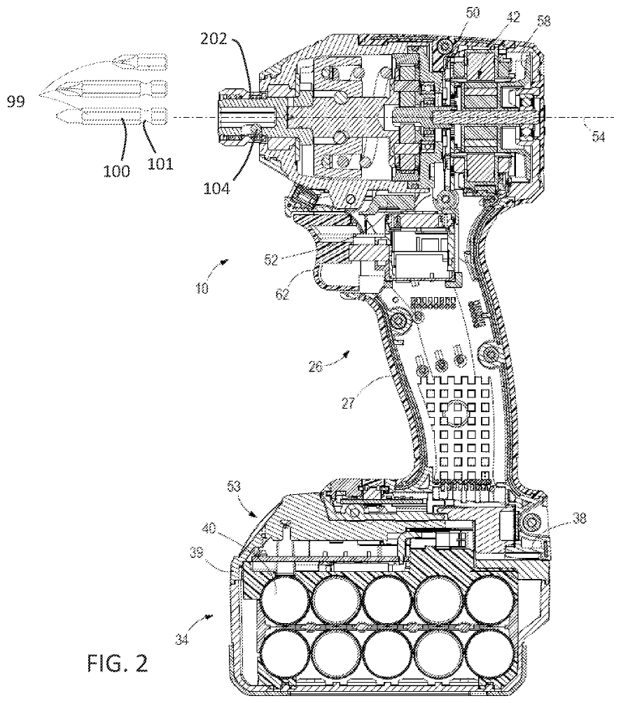

With continued reference to FIG. 1, the power tool 10 has a battery pack 34 removably coupled to a battery receptacle 38 located at a bottom end of the handle portion 26. The battery pack 34 includes a housing 39 supporting battery cells 40 (FIG. 2), which are electrically connected to provide the desired output (e.g., nominal voltage, current capacity, etc.) of the battery pack 34. A battery power display 53 indicates the power level remaining in the battery pack 34 (FIG. 1). In other embodiments, the power tool 10 may include a power cord for electrically connecting the power tool 10 to a source of AC power. As a further alternative, the power tool 10 may be configured to operate using a different power source (e.g., a pneumatic power source, etc.).

Referring to FIG. 2, a motor 42, supported within the motor housing portion 18, receives power from the battery pack 34 when the battery pack 34 is coupled to the battery receptacle 38. In the illustrated embodiment, the motor 42 is a brushless direct current (“BLDC”) electric motor having a stator 46 and a rotor or drive shaft 50. A button 52, extending laterally from the housing 14, allows an operator to change the direction that the motor 42 rotates the drive shaft 50 that is rotatable about an axis 54 relative to the stator 46. In other embodiments, other types of motors may be used. A fan 58 is coupled to the drive shaft 50 (e.g., via a splined connection) behind the motor 42.

The power tool 10 also includes a switch 62 (e.g., trigger switch) supported by the housing 14 for operating the motor 42 via suitable control circuitry provided on one or more printed circuit board assemblies (“PCBAs”) that control power supply and command of the motor 42. In other embodiments, the power tool 10 may include a power cord for connecting to a source of AC power. As a further alternative, the power tool 10 may be configured to operate using a non-electrical power source (e.g., a pneumatic or hydraulic power source, etc.). In some embodiments, the switch 62 that is coupled to the handle portion 26 and actuatable to selectively electrically connect the motor 42 and the battery pack 34 to provide DC power to the motor 42.

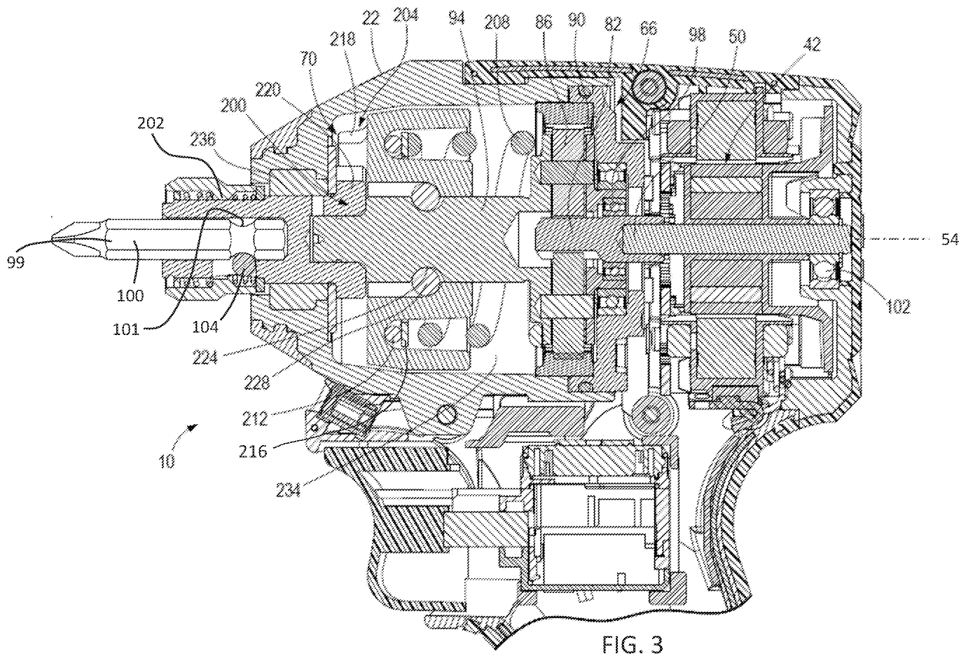

With reference to FIG. 3, the illustrated power tool 10 includes a gear assembly 66 coupled to the drive shaft 50 and a drive assembly or impact assembly 70 coupled to an output of the gear assembly 66. The gear assembly 66 is at least partially housed within the gear case 22. The gear assembly 66 may be configured in any of a number of different ways to provide a speed reduction between the drive shaft 50 and an input of the drive assembly 70.

Referring to FIGS. 2 and 3, the gear assembly 66 includes a pinion 82 formed, pressed, or otherwise coupled for co-rotation with the drive shaft 50, a plurality of planet gears 86 meshed with the pinion 82, and a ring gear 90 meshed with the planet gears 86 and rotationally fixed within the gear case 22. The planet gears 86 are mounted on a camshaft 94 of the drive assembly 70 such that the camshaft 94 acts as a planet carrier. Accordingly, rotation of the drive shaft 50 rotates the planet gears 86, which then orbit along the inner circumference of the ring gear 90 and thereby rotate the camshaft 94. The gear assembly 66 thus provides a gear reduction ratio from the drive shaft 50 to the camshaft 94. The drive shaft 50 is rotatably supported by a first or forward bearing 98 and a second or rear bearing 102.

The drive assembly 70 of the power tool 10 includes an output spindle 200, which in the illustrated embodiment is an anvil, extending from the gear case 22. A bit holder or retainer 202 coupled to the output spindle 200 to support a tool bit 99 (e.g., a screwdriver bit, drill bit, etc.), which can be retained and driven by the output spindle 200 to perform work on a workpiece (e.g., a fastener, plank, etc.). With specific reference to FIG. 2, the tool bit 99 may have a hexagonal (e.g., cross-section) body or shank 100 with a groove 101, such as a power groove, formed in a portion of the shank 100. As described in greater detail below, the groove 101 may be configured to receive one or more ball detents 104 to inhibit removal of the tool bit 99 from the bit retainer 202.

The drive assembly 70 is configured to convert the continuous rotational output or torque provided by the motor 42 and gear assembly 66 to a striking rotational force or intermittent applications of torque to the output spindle 200 when the reaction torque on the output spindle 200 (e.g., due to engagement between the tool bit 99 and a fastener being worked upon) exceeds a certain threshold. In the illustrated embodiment of the power tool 10, the drive assembly 70 includes the camshaft 94, a hammer 204 supported on and axially slidable relative to the camshaft 94, and the output spindle 200.

The illustrated drive assembly 70 further includes a spring 208 biasing the hammer 204 toward the front of the power tool 10 (i.e., toward the left in FIG. 3). In other words, the spring 208 biases the hammer 204 in an axial direction toward the output spindle 200, along the axis 54. A thrust bearing 212 and a thrust washer 216 are positioned between the spring 208 and the hammer 204. The thrust bearing 212 and the thrust washer 216 allow for the spring 208 and the camshaft 94 to continue to rotate relative to the hammer 204 after each impact strike when hammer lugs 218 on the hammer 204 engage with corresponding anvil lugs 220 on the output spindle 200 and rotation of the hammer 204 momentarily stops. A washer may be located between the output spindle 200 and a front end of the gear case 22 in some embodiments. The camshaft 94 further includes cam grooves 224 in which corresponding cam balls 228 are received. The cam balls 228 are in driving engagement with the hammer 204 and movement of the cam balls 228 within the cam grooves 224 allows for relative axial movement of the hammer 204 along the camshaft 94 when the hammer lugs 218 and the anvil lugs 220 are engaged and the camshaft 94 continues to rotate.

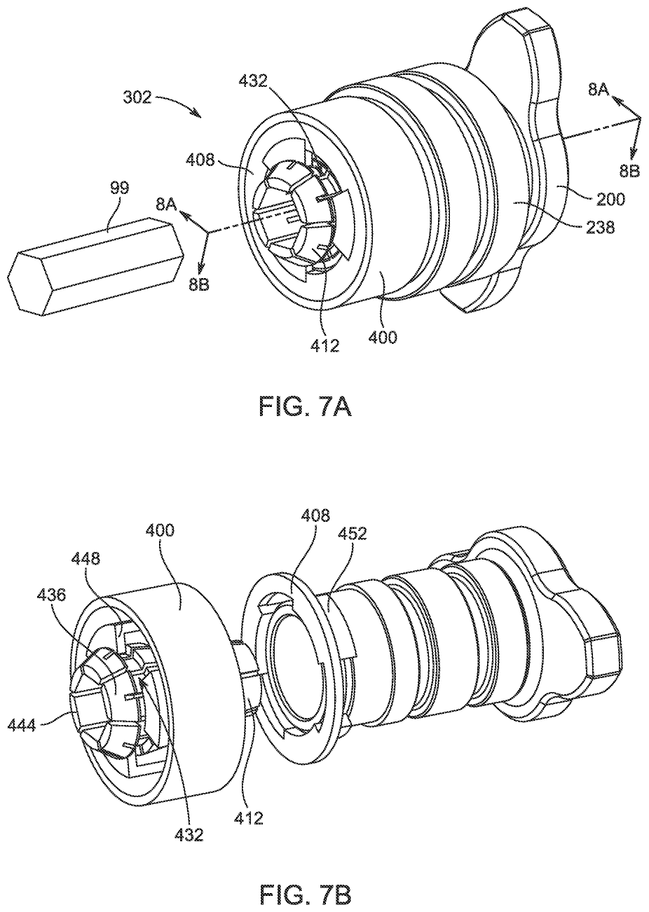

Referring still to FIGS. 1-3, the output spindle 200 is rotatably supported by a bushing 236 fixed within a front portion of the gear case 22. During operation of the power tool an operator depresses the switch 62 to activate the motor 42, which continuously drives the gear assembly 66 and the camshaft 94 via the drive shaft 50. As the camshaft 94 rotates, the cam balls 228 drive the hammer 204 to co-rotate with the camshaft 94, and the hammer lugs 218 engage driven surfaces of the anvil lugs 220 to provide an impact and to rotatably drive the output spindle 200 and the tool bit 99. In some embodiments, such as those illustrated in FIGS. 7A-11B and 14, the output spindle 200 may alternatively be supported by one or more bearings 238.

After each impact, the hammer 204 moves or slides rearward along the camshaft 94, away from the output spindle 200, so that the hammer lugs 218 disengage the anvil lugs 220. As the hammer 204 moves rearward, the cam balls 228 situated in the respective cam grooves 224 in the camshaft 94 move rearward in the cam grooves 224. The spring 208 stores some of the rearward energy of the hammer 204 to provide a return mechanism for the hammer 204. After the hammer lugs 218 disengage the respective anvil lugs 220, the hammer 204 continues to rotate and moves or slides forwardly, toward the output spindle 200, as the spring 208 releases its stored energy, until the drive surfaces of the hammer lugs 218 re-engage the driven surfaces of the anvil lugs 220 to cause another impact.

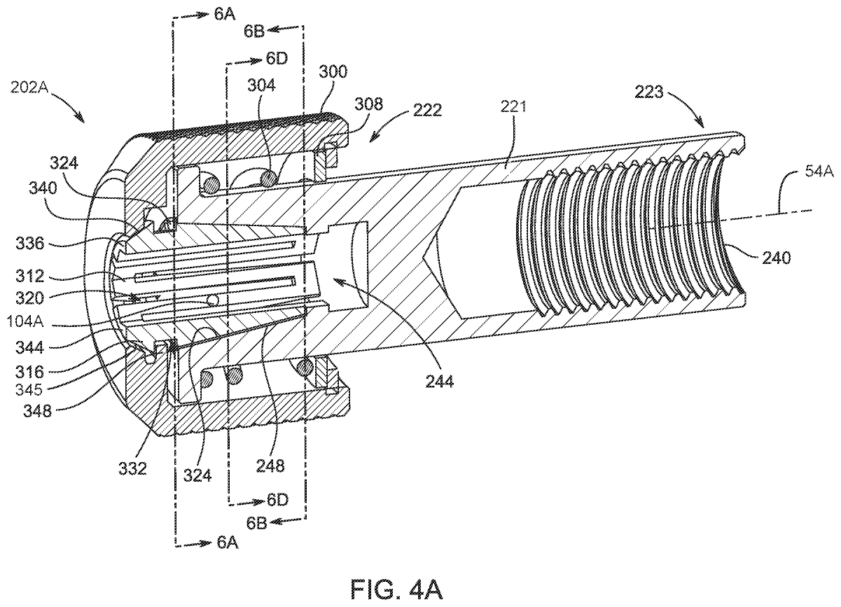

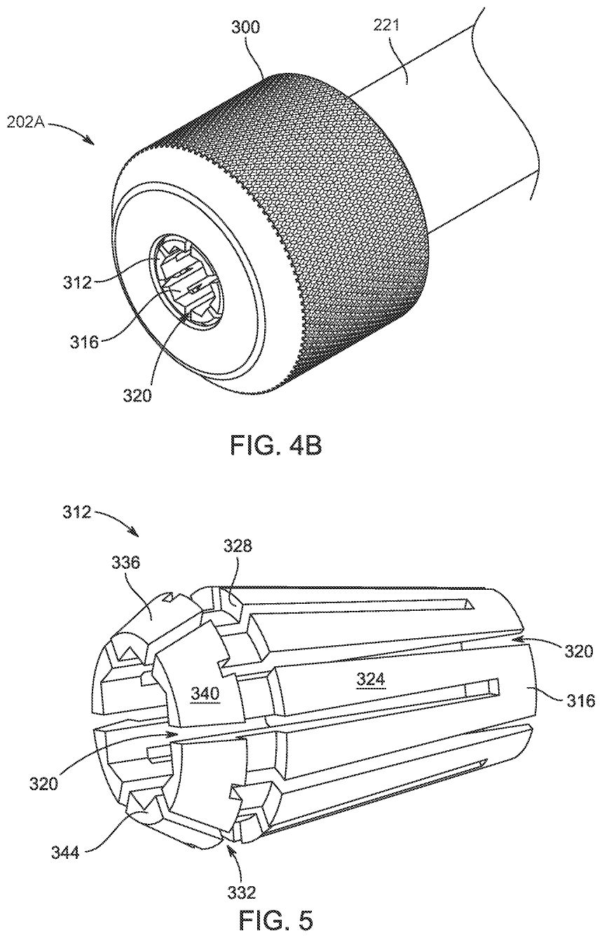

FIGS. 4A-18 illustrate embodiments of bit retainers which may be incorporated into the power tool 10 described above with reference to FIGS. 1-3 (e.g., in place of the bit retainer 202) for coupling the tool bit 99 to the output spindle 200. Although the bit retainers may be described herein with reference to the power tool 10, it should be understood that the bit retainers may be implemented in other power tools with output spindles, including, but not limited to, impact wrenches, drills, powered screwdrivers, ratchets, precision torque tools, etc. The bit retainers described herein may also, in some embodiments, be configured as adapters to interface with existing bit retainers on such power tools.

With reference to FIGS. 4A-6B, a bit retainer 202A embodying aspects of the present disclosure includes a body 221 having a driving end portion 222 opposite a receiving portion 223, which receives torque from an output spindle of a power tool, such as the output spindle 200 of the power tool 10. In some embodiments, the receiving portion 223 is coupled to the output spindle 200 by a threaded connection, a press-fit, or any other suitable mechanical connection allowing the bit retainer 202A to co-rotate with the output spindle 200. In other embodiments, the body 221 may be an integral portion of the output spindle 200.

With reference to FIGS. 4A and 4B, the illustrated bit retainer 202A is configured to interface with a tool bit, such as the tool bit 99 illustrated in FIGS. 2-3, so that that the tool bit 99 is coupled for co-rotation with the output spindle 200. A receiving aperture 244 extends into the driving end portion 222. The bit retainer 202A further includes a sleeve 300 co-axially supported on the body 221 and surrounding the driving end portion 222. The sleeve 300 is moveably supported on the body 221 and selectively moveable along a rotational axis 54A of the bit retainer 202A by a user. The axis 54A may be coaxial with the axis 54 (FIG. 3).

In the illustrated embodiment, a spring 304 is constrained between the sleeve 300 and the body 221 to bias the sleeve 300 in a rearward direction (i.e. to the right in FIG. 4A). The sleeve 300 includes a spring retainer 308 that surrounds the body 221 and supports the sleeve 300 on the body 221. The spring retainer 308 constrains one end of the spring 304 while the body 221 retains an opposing end of the spring 304, such that the spring 304 bears against the spring retainer 308 to bias the sleeve 300 rearwardly.

The bit retainer 202A further includes a collet 312 at least partially received within the receiving aperture 244 of the body 221 and selectively compressible by the body 221 in response to movement of the sleeve 300. As illustrated in FIGS. 4A-5, the collet 312 includes a plurality of jaws 316 each separated by a slot 320. In the illustrated embodiment, each slot 320 is open to an opposite end relative to an adjacent slot 320. Each of the jaws 316 terminates at a shoulder 328 that converges with a slot or groove 332 extending around the collet 312. An axially opposite side of the groove 332 converges with teeth 336 that define a front face 344 of the collet 312. Each of the jaws 316 includes a first or rearward wedge surface 324 and a second or forward wedge surface 340 separated from the rearward wedge surface 324 by a gap formed by a groove adjacent the shoulder 328. In some embodiments, the collet 312 is a standardized collet, such as an ER-20 collet, or an ER-11 collet. In some embodiments, the collet 312 may be interchangeable with other collets of different sizes and/or geometries.

The first wedge surfaces 324 of the illustrated collet 312 and a corresponding first clamping surface 248 of the receiving aperture 244 are each frustoconically shaped. The second wedge surfaces 340 and a corresponding second clamping surface 345 on an inner side of the sleeve 300 are also frustoconically shaped. The first wedge surfaces 324 and the first clamping surface 248 are engageable with one another, and the second wedge surfaces 340 and second clamping surface 345 are engageable with on another, to displace the jaws 316 inwardly and/or rearwardly, thereby compressing the jaws 316 around the tool bit 99 to clamp the tool bit 99 with the collet 312.

The illustrated collet 312 includes detents 104A integrally formed with jaws 316 of the collet 312. The detents 104A are configured to engage the groove 101 on the tool bit 99 (FIG. 3) to axially retain the tool bit 99. The sleeve 300 includes a lip 348 positioned in the groove 332 on the collet 312 such that axial movement of the sleeve 300 controls movement of the collet 312 relative to the body 221. For example, as the sleeve 300 is moved forwardly against the bias from the spring 304, the collet 312 is pulled-out or moved away from the receiving aperture 244, such that the jaws 316 are not compressed by the body 221. Alternatively, the sleeve 300 may be released by the user, such that the bias from the spring 304 pulls or draws the collet 312 into the receiving aperture 244 to compress the jaws 316. As the jaws 316 compress, the detents 104A are pressed inwardly to engage the tool bit 99.

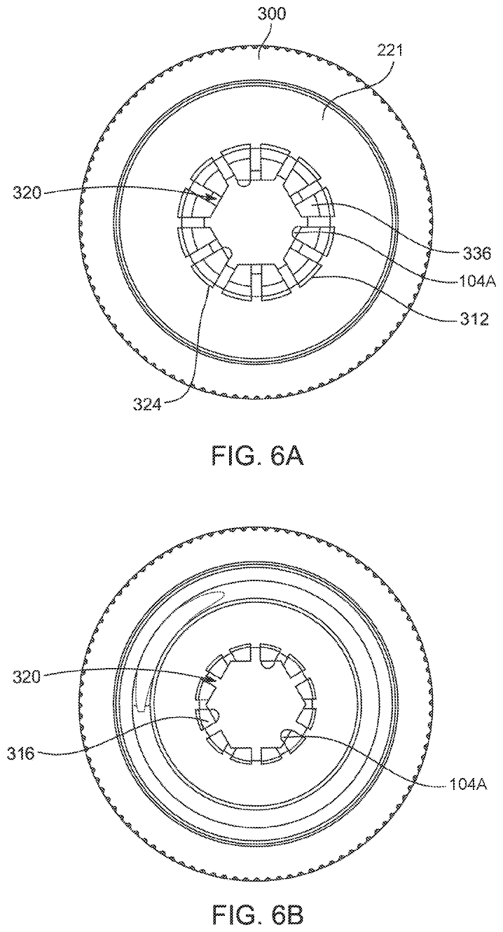

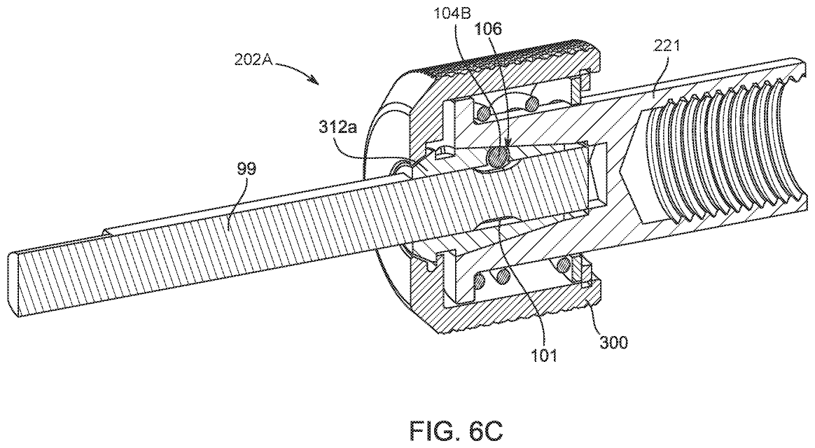

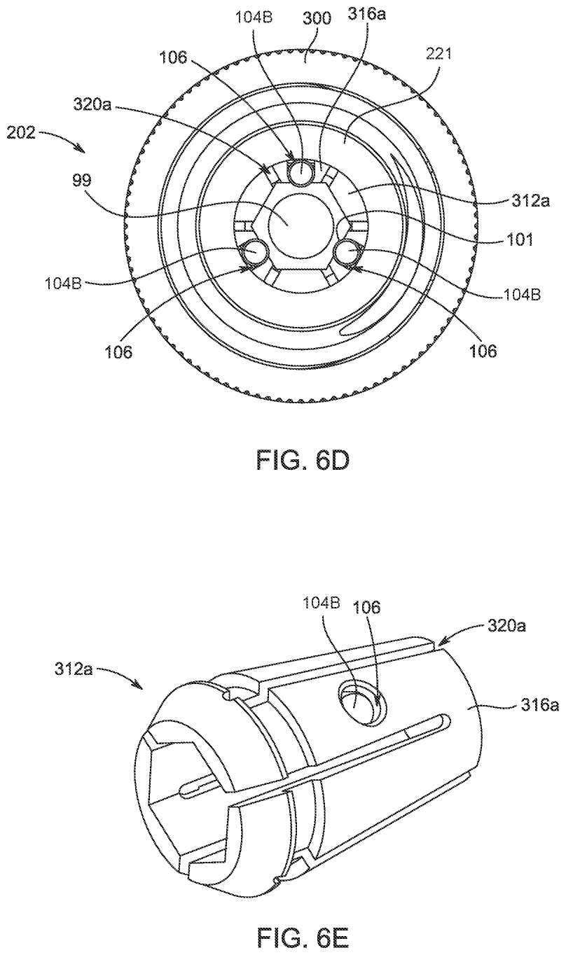

With reference to FIGS. 6C-6E, the bit retainer 202A may include an alternate collet 312a receivable in the body 221 and selectively compressible by the body 221 in response to movement of the sleeve 300. The alternate collet 312a supports ball detents 104B in apertures 106 that may be integrally formed with jaws 316a of the alternate collet 312a. In the illustrated embodiment, the alternate collet 312a includes three apertures 106 radially offset relative to each other by an angle, such as approximately 120 degrees. Each aperture 106 may be formed in the jaws 316a of the alternate collet 312a between radially adjacent slots 320a. As illustrated in FIG. 6D, the apertures 106 may be tapered to retain the ball detents 104B in each of the apertures 106 between the body 221 and the groove 101 on the tool bit 99. While the ball detents 104B engage the groove 101 and the alternate collet 312a is compressed by the body 221, the bit retainer 202A inhibits removal of the tool bit 99.

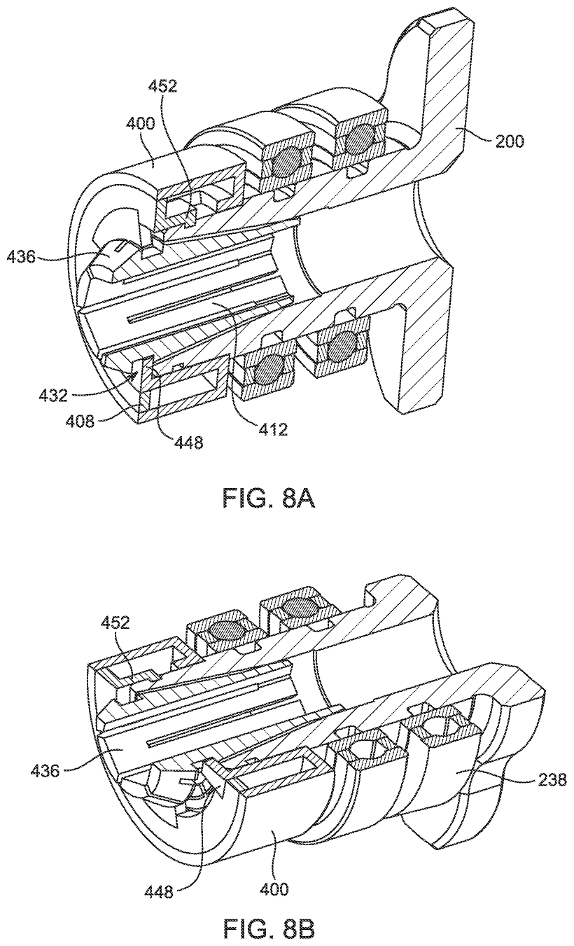

FIGS. 7A-8B illustrate a bit retainer 302 according to another embodiment. The bit retainer 302, like the bit retainers described above, is usable with the power tool 10 (or other power tools) to couple the tool bit 99 for co-rotation with the output spindle 200. In the illustrated embodiment, the bit retainer 302 is incorporated into the output spindle 200, such that the output spindle 200 defines a body of the bit retainer 302; however, the bit retainer 302 may include a separate body coupled to the output spindle 200 in any suitable manner in other embodiments. The bit retainer 302 is similar in some aspects to the bit retainer 202A described above, and features of the bit retainer 302 corresponding with features of the bit retainer 202A are given like reference numbers plus ‘100,’ and the following description focuses primarily on differences between the bit retainer 302 and the bit retainer 202A.

As illustrated in FIGS. 7A-8B, a spring retainer 408 is coupled to the output spindle 200 and provided adjacent the front face 444 of the teeth 436. The lips 448 of the sleeve 400 rest in the groove 432 of the collet 412 and are separated by axially extending tabs 452. The tabs 452 are received in the output spindle 200 and axially constrained relative to the sleeve 400, such that the sleeve 400 is moveable relative to the output spindle 200, and the spring retainer 408 is not. Stated another way, the sleeve 400 is biased rearwardly but moveable against the bias by the user to move the collet 412 out of the output spindle 200 via the lips 448 on the sleeve 400 engaging the jaws 416 on the collet 412.

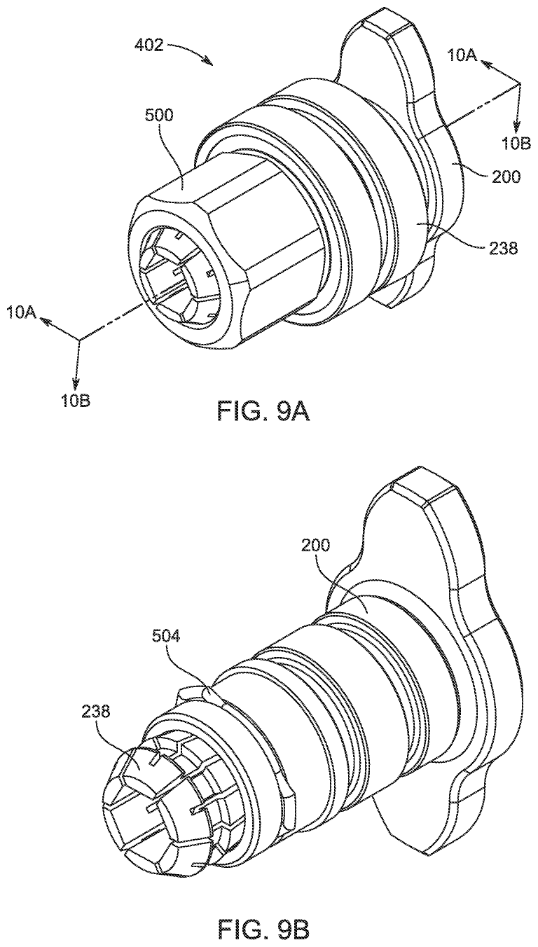

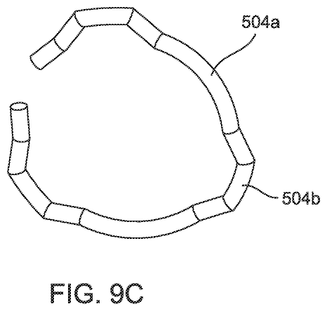

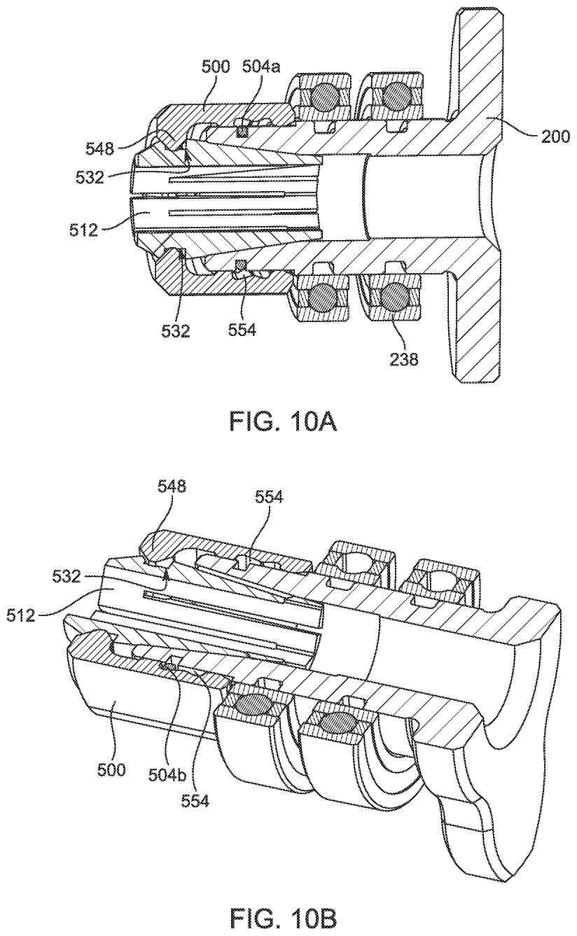

FIGS. 9A-10B illustrate a bit retainer 402, according to another embodiment. The bit retainer 402, like the bit retainers described above, is usable with the power tool 10 (or other power tools) to couple the tool bit 99 for co-rotation with the output spindle 200. The bit retainer 402 is similar in some aspects to the bit retainer 302 described above, and features of the bit retainer 402 corresponding with features of the bit retainer 302 are given like reference numbers plus ‘100,’ and the following description focuses primarily on differences between the bit retainer 402 and the bit retainer 302.

As illustrated in FIGS. 9A-10B, the spring 504 is in the form of a retaining ring mounted on the output spindle 200 to engage both the output spindle 200 and the sleeve 500. As illustrated in FIG. 9C, the spring 504 may be triangular and abut against a helical groove 554 formed in the sleeve 500. The spring 504 includes generally circular or curved portions 504a separated by flatter or pointed portions 504b. As illustrated in FIGS. 10A and 10B, the curved portions 504a engage the output spindle 200 and the pointed portions 504b engage the helical groove 554, which include axially offset detent portions. As the sleeve 500 is moved axially between the detent portions, the spring 504 rides the helical groove 554, which causes the sleeve 500 and collet 512 to move axially relative to the output spindle 200. During movement of the sleeve 500 between the detent portions, the lips 548 extend from the sleeve 500 and into the groove 532 formed in the collet 512 to move the collet 512 with the sleeve 500 relative to the output spindle 200.

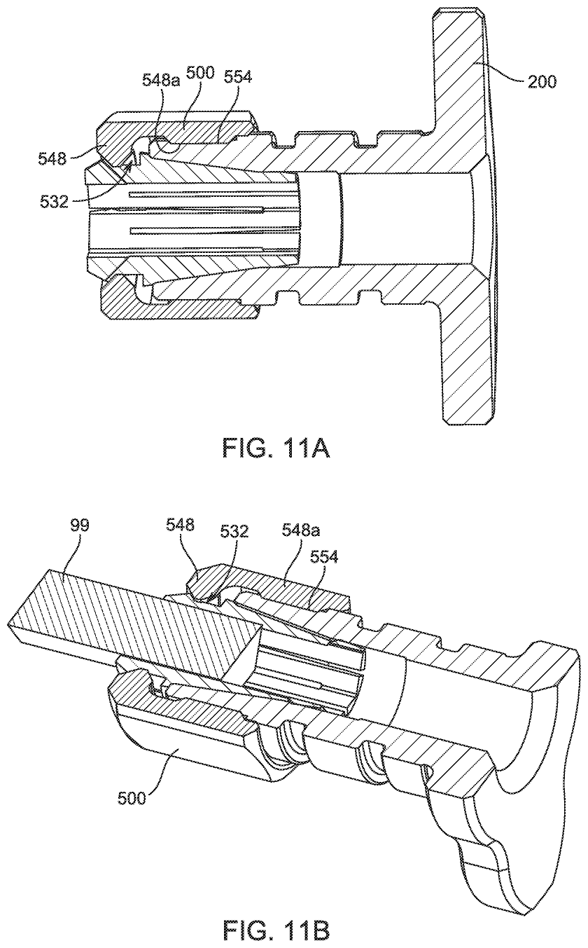

In some embodiments of the bit retainer 402, as illustrated in FIGS. 11A and 11B, the helical groove 554 may be formed on the output spindle 200 rather than on the sleeve 500. In such embodiments, the sleeve 500 includes a second lip 548a extending from the sleeve 500 and into the helical groove 554. The first lip 548 extends into the groove 532 formed in the collet 512. As the sleeve 500 is rotated about the output spindle 200, the second lip 548a engages the helical groove 554 to move the sleeve 500 axially relative to the output spindle 200. In turn, the first lip 548 engages the groove 532 in the collet 512 to move the collet 512 into/out of the output spindle 200 (e.g., axially). In other words, the sleeve 500 may be rotated to convert rotational movement of the sleeve 500 into axial movement of the collet 512.

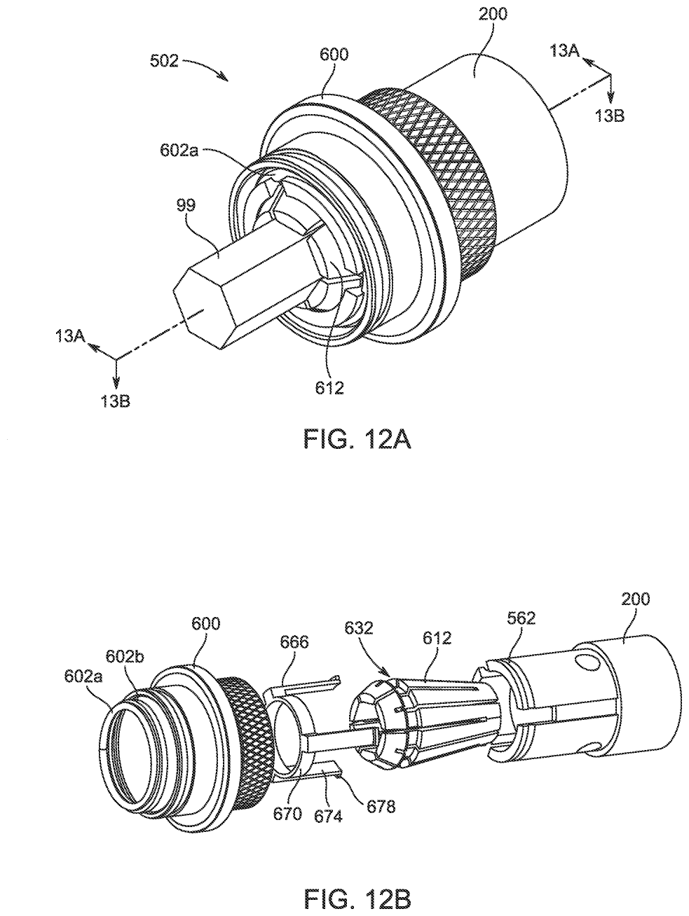

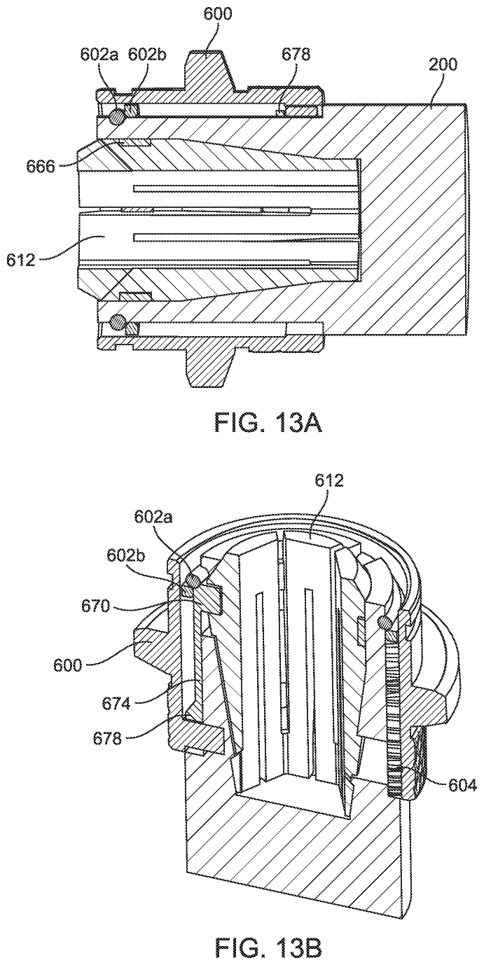

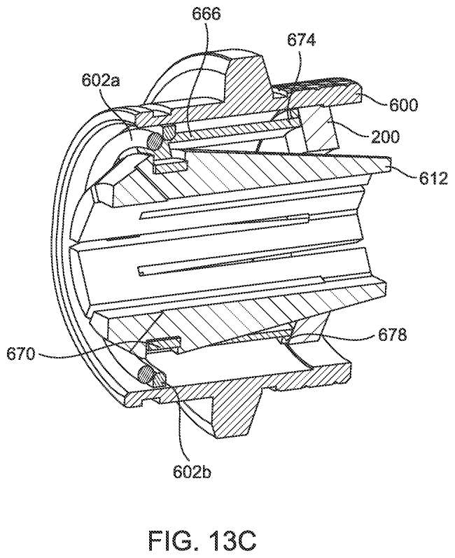

FIGS. 12A-13C illustrate a bit retainer 502, according to another embodiment. The bit retainer 502, like the bit retainers described above, is usable with the power tool 10 (or other power tools) to couple the tool bit 99 for co-rotation with the output spindle 200. The bit retainer 502 is similar in some aspects to the bit retainer 302 described above, and features of the bit retainer 502 corresponding with features of the bit retainer 302 are given like reference numbers plus ‘200,’ and the following description focuses primarily on differences between the bit retainer 502 and the bit retainer 302.

As illustrated in FIGS. 12A and 12B, the spring retainer 602 is a spring retaining assembly that includes first and second spring retainers 602a, 602b positioned between the output spindle 200 and the sleeve 600. Specifically, the first spring retainer 602a may be a flexible O-ring or snap ring slotted in a receiving groove 662 formed in the output spindle 200. The second spring retainer 602b encircles the collet 612 an engages with the sleeve 600. The bit retainer 502 further includes a puller 666 seated in the groove 632 at one end and bearing against the output spindle 200 and/or the sleeve 600 at another opposing end. In the illustrated embodiment, the puller 666 is positioned between the second spring retainer 602b and the collet 612. As the sleeve 600 is moved axially the puller 666 engages and moves the collet 612.

In the illustrated embodiment, the puller 666 includes an annular band 670 that is seated in the groove 632 and legs 674 extending from the annular band 670. The legs 674 support feet 678 extending outwardly. As illustrated in FIGS. 13A-13C, the spring 604 is positioned between the first and second spring retainers 602a, 602b and the output spindle 200 in an area separated from the puller 666 so as to not interfere with the engagement between the puller 666 and the sleeve 600.

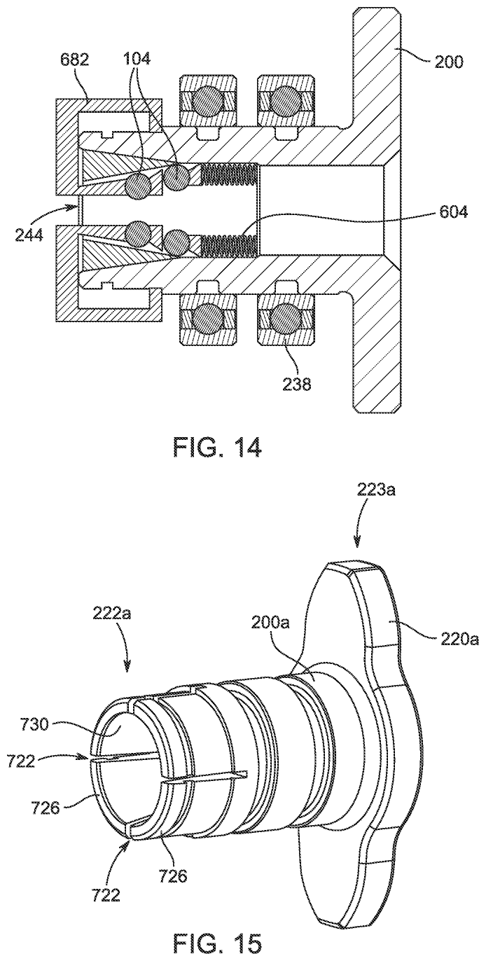

In some embodiments, as illustrated in FIG. 14, the collet 612 may be replaced with a plurality of axially offset ball detents 104. One or more sets of the ball detents 104 may be coupled to a carrier 682 that is axially moveable relative to the output spindle 200. The carrier 682 supports the ball detents 104 in an angled or tapered arrangement, which may provide a polygonal (e.g., hexagonal) profile to drivably engage the tool bit 99. The carrier 682 is biased by the springs 604 to push the carrier 682 and ball detents 104 away from the output spindle 200. When pressed away, the tool bit 99 can fit into the aperture 244 of the output spindle 200. Once released, the spring 604 pushes the carrier 682 forward until the ball detents 104 engagement with the tool bit 99. In other embodiments, each of the ball detents 104 may be supported by a respective, and independently movable, carrier. The two carriers may be coupled to a sleeve for axial movement with the sleeve relative to the output spindle 200.

In some embodiments, as illustrated in FIG. 15, an alternate output spindle 200a may be usable with the power tool 10 and/or the various bit retainer embodiments described herein. The alternate output spindle 200a may include slots 722, such as cuts or kerf cuts, similar to the slots 320 of the bit retainer 202A of FIG. 4A. The slots 722 may be formed between radially offset and adjacent jaws 726, which may be selectively compressed inwardly or separated outwardly. In the illustrated embodiment, the slots 722 are formed in the driving end portion 222a opposite the impact receiving portion 223a. Some embodiments of the alternate output spindle 200a include a flat, hexagonal, or axial inner surface 730. Other embodiments of the alternate output spindle 200a include an angled or tapered inner surface 730. In some embodiments, the jaws 726 may be compressed inwardly (e.g., in response to movement of a sleeve of a bit retainer described herein) to apply additional clamping force to the jaws of the collet. In some embodiments, the jaws 726 may be sufficiently flexible and apply a sufficient clamping force directly to the tool bit 99, such that the collet may be omitted.

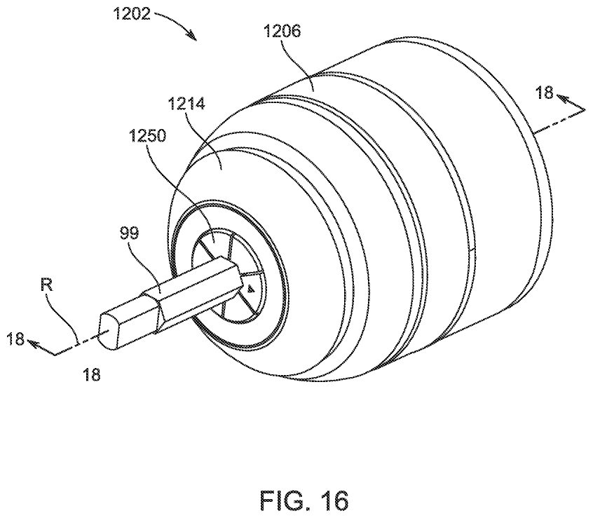

FIGS. 16-18 illustrate a bit retainer 1202 according to another embodiment of the present disclosure. The bit retainer 1202, like the bit retainers described above, is usable with the power tool 10 (or other power tools) to couple the tool bit 99 for co-rotation with the output spindle 200.

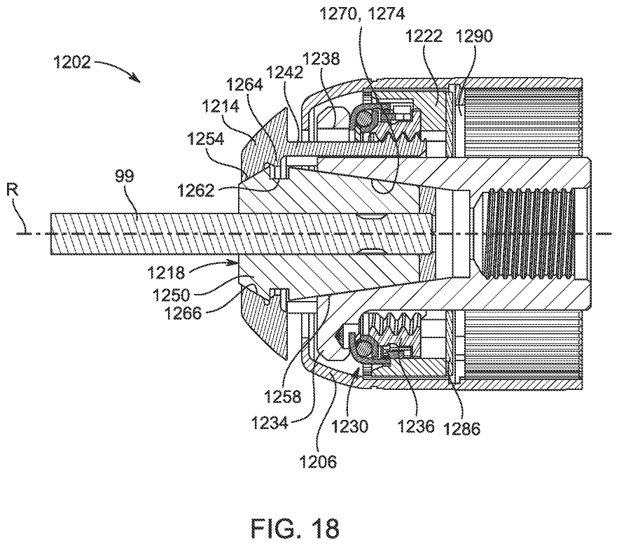

The illustrated bit retainer 1202 includes a sleeve 1206 (FIGS. 16 and 18) surrounding a body 1210, a cap 1214, a collet 1218, a ring 1222, a nut 1226, and a ratchet assembly 1230. The body 1210 is configured to be coupled for co-rotation with the output spindle of a power tool (e.g., the output spindle of a drill, the output spindle 200 of the power tool 10, etc.), such that the body 1210 is rotatable about a rotational axis R.

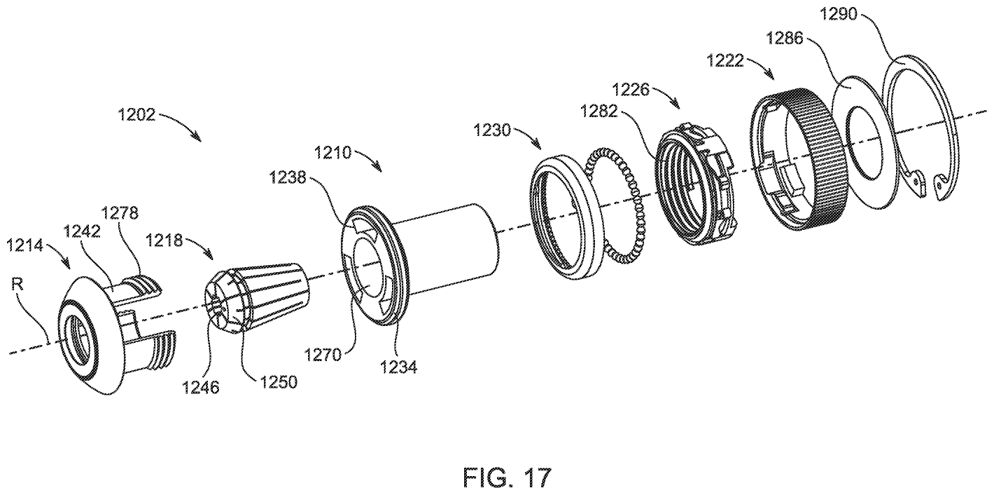

Best illustrated in FIG. 17, a flange 1234 is formed adjacent a front end of the body 1210. The flange 1234 includes a plurality of slots 1238 that receive rearward extensions 1242 of the cap 1214 to couple the cap 1214 for co-rotation with the body 1210. The extensions 1242 are slidably received by the slots 1238, such that the cap 1214 may translate along the rotational axis R relative to the body 1210. In the illustrated embodiment, the flange 1234 includes three slots 1238 equally spaced from one another by 120 degrees, and the cap 1214 includes three corresponding rearward extensions 1242. In other embodiments, the flange 1234 and cap 1214 may include other numbers and/or arrangements of slots 1238 and extensions 1242. In yet other embodiments, the cap 1214 may be coupled for co-rotation with the body 1210 by other arrangements that also permit translation of the cap 1214 relative to the body 1210.

With continued reference to FIG. 17, the collet 1218 in the illustrated embodiment is a standardized collet, such as an ER-20 collet. The ER-20 collet may be able to accept bit shanks having nominal diameters in a range of 1 to 13 millimeters (0.039 to 0.512 inches). The collet 1218 may be interchangeable with other standardized collets, such as an ER-11 collet. The ER-11 collet may be able to accept bit shanks having nominal diameters in a range of 0.5 to 7 millimeters (0.20 to 0.276 inches). The bit retainer 1202 thus allows for a user to accommodate a wide range of common tool bit sizes, using standardized collets. In the illustrated embodiment, the collet 1218 has a hexagonal bore 1246 defined between a plurality of jaws 1250 of the collet 1218, such that the collet 1218 is configured to receive hexagonal shank tool bits; however, in other embodiments, the collet 1218 may have a round bore, a square bore, or a bore of any other desired shape. In other embodiments, collet 1218 may be any of the collets described and illustrated herein.

With reference to FIG. 18, each of the jaws 1250 of the illustrated collet 1218 is positioned at least partially within the body 1210 and includes a forward wedge surface 1254 and a rearward wedge surface 1258. The forward wedge surface 1254 and rearward wedge surface 1258 are oriented at oblique angles relative to the rotational axis R and relative to one another. A groove 1262 is defined between the forward wedge surface 1254 and the rearward wedge surface 1258, and the forward wedge surface 1258 and rearward wedge surface 1258 each converge toward the rotational axis R in directions away from the groove 1262. The grooves 1262 in the jaws 1250 are aligned and receive an inwardly-projecting rib 1264 formed on the cap 1214. In the illustrated embodiment, the grooves 1262 are wider in the axial direction that the rib 1264, such that limited axial movement of the cap 1214 relative to the jaws 1250 is permitted (e.g., when clamping the tool bit 99, as described in greater detail below). The rib 1264 is also engageable with the ends of the grooves 1262 to cause the collet 1218 to translate with the cap 1214 along the rotational axis R (e.g., to remove and replace the collet 1218, as described in greater detail below).

With continued reference to FIG. 18, the cap 1214 has a first inner clamping surface 1266 engageable with the forward wedge surfaces 1254 of the jaws 1250, and the body 1210 has a tapered bore 1270 defining a second inner clamping surface 1274 engageable with the rearward wedge surfaces 1258 of the jaws 1250. The wedge surfaces 1254, 1258 and clamping surfaces 1266, 1274 are frustoconical in the illustrated embodiment; however, in other embodiments, the wedge surfaces 1254, 1258 and clamping surfaces 1266, 1274 may have non-round cooperating tapered geometries, such as a tapered hexagonal geometry.

Referring to FIGS. 17-18, in the illustrated embodiment, the rearward extensions 1242 of the cap 1214 have external thread segments 1278 threadably coupled to internal threads 1282 of the nut 1226. As such, rotation of the nut 1226 relative to the cap 1214 causes the cap 1214 to translate along the rotational axis R by virtue of the threaded coupling. In the illustrated embodiment, the nut 1226 is coupled to the ring 1222 via the ratchet assembly 1230, and the ring 1222 is coupled for co-rotation with the sleeve 1206 (e.g., by cooperating splines or any other suitable geometry on the outer surface of the ring 1222 and the inner surface of the sleeve 1206). As described in greater detail below, the ratchet assembly 1230 provides a tactile indication to a user once a proper clamping force on the tool bit 99 has been achieved and may also prevent or inhibit over-tightening by interrupting torque transmission from the ring 1222 to the nut 1226 above a predetermined torque threshold. In some embodiments, the ratchet assembly 1230 may be omitted, such that the nut 1226 may be directly coupled to the ring 1222 for co-rotation therewith; or, the nut 1226 and the ring 1222 may optionally be formed as a single component coupled for co-rotation with the sleeve 1206. The ratchet assembly 1230, nut 1226, and ring 1222 are retained around the body 1210 of the bit retainer 1202 between the flange 1234 and a washer 1286. The washer 1286 is axially secured by a retaining ring 1290 coupled to the sleeve 1206.

In use, a user inserts a selected tool bit 99 into the bore 1246 between the jaws 1250 of the collet 1218. To clamp the tool bit 99 between the jaws 1250, the user grasps the sleeve 1206 and rotates the sleeve 1206 in a tightening direction (e.g., clockwise) about the rotational axis R. The ring 1222 co-rotates with the sleeve 1206 (e.g., due to the spline connection between the ring 1222 and the sleeve 1206) and causes rotation of the nut 1226 through the ratchet assembly 1230. As the nut 1226 rotates, the cap 1214 retracts inwardly (i.e., to the right with reference to the orientation of FIG. 18), due to the threaded coupling between the thread segments 1278 on the rearward extensions 1242 and the threads 1282 of the nut 1226. As the cap 1214 retracts, the inner clamping surface 1266 of the cap 1214 engages the forward wedge surfaces 1254 of the jaws 1250 of the collet 1218, causing the jaws 1250 to move inwardly and rearwardly (i.e., to the right in FIG. 18). As the jaws 1250 move rearwardly, the second inner clamping surface 1274 engages the rearward wedge surfaces 1258 of the jaws 1250, further causing the jaws 1250 to move inwardly. This continues until the tool bit 99 is firmly clamped between the jaws 1250 of the collet 1218.

In the illustrated embodiment, once a predetermined torque is reached on the sleeve 1206 corresponding with a proper clamping force on the tool bit 99, the ratchet assembly 1230 begins to slip, producing tactile and/or audible feedback to the user indicating that the tool bit 99 is secured. As the ratchet assembly 1230 slips, torque transmission from the ring 1222 to the nut 1226 is interrupted to prevent or inhibit overtightening.

To remove the tool bit 99, the user grasps the sleeve 1206 and rotates the sleeve 1206 in a loosening direction (e.g., counterclockwise) about the rotational axis R. This causes the cap 1214 to extend (i.e., move to the left in FIG. 18), which allows the jaws 1250 of the collet 1218 to move away from the tool bit 99 and release the clamping force on the tool bit 99. In some embodiments, the sleeve 1206 is rotated 360 degrees or less from a secured position, in which the tool bit 99 is firmly clamped between the jaws 1250 (e.g., at the predetermined torque threshold of the ratchet assembly 1230) and a release position, in which the tool bit 99 may be freely withdrawn from the bit retainer 1202. In some embodiments, the sleeve 1206 is rotated by a displacement of 180 degrees or less from the secured position to the release position. In yet other embodiments, the sleeve 1206 is rotated 90 degrees or less from the secured position to the release position. In yet other embodiments, the sleeve is rotated 60 degrees or less from the secured position to the release position. In yet other embodiments, the sleeve 1206 is rotated between 30 degrees and 40 degrees from the secured position to the release position.

If the user desires to replace the collet 1218 (e.g., to interchange the collet 1218 with another standardized collet able to accommodate a different range of sizes and/or geometries of tool bit), the user may continue rotating the sleeve 1206 in the loosening direction. By doing so, the cap 1214 continues to extend (to the left in FIG. 18), until the thread segments 1278 on the rearward extensions 1242 decouple from the threads 1282 of the nut 1226. At this point, the user can remove the cap 1214 from the remaining assembly of the bit retainer 1202 and then remove the collet 1218 from the cap 1214. The replacement collet 1218 can then be positioned in the cap 1214, and the cap 1214 reattached to the remaining assembly of the bit retainer 1202 by inserting the rearward extensions 1242 into the slots 1238 and rotating the sleeve 1206 in the tightening direction to re-establish the threaded coupling between the thread segments 1278 and the threads 1282 of the nut 1226.

Various features and aspects of the present disclosure are set forth in the following claims.

What is claimed is:

1. A bit retainer configured to couple a tool bit to an output spindle of a power tool, the bit retainer comprising:
a body coupled for co-rotation with the output spindle about a rotational axis;
a collet including a plurality of jaws positioned at least partially within the body, the collet defining a bore between the plurality of jaws configured to receive the tool bit;
a wedge surface engageable with the collet; and
a sleeve surrounding the body, wherein the sleeve is movable relative to the body to engage the wedge surface against the collet and compress the plurality of jaws around the tool bit.

2. The bit retainer of claim 1, wherein the wedge surface is formed within the body, and wherein the sleeve is movable to translate the collet along the wedge surface.

3. The bit retainer of claim 1, further comprising a cap coupled to the body, wherein the wedge surface is formed on the cap, and wherein the sleeve is movable to translate the cap relative to the body.

4. The bit retainer of claim 3, further comprising a nut coupled to the sleeve, wherein the cap includes a rearward extension threadably coupled to the nut such that rotation of the nut relative to the cap causes the cap to translate.

5. The bit retainer of claim 4, further comprising a ring coupled for co-rotation with the sleeve and a ratchet assembly coupled to the ring, wherein the ratchet assembly is configured to interrupt torque transmission between the ring and the nut above a predetermined torque threshold corresponding with a secured state, in which the tool bit is securely clamped between the plurality of jaws.

6. The bit retainer of claim 5, wherein the sleeve is rotatable in a loosening direction from the secured state to a release state, in which the tool bit is freely removable from the bit retainer, and wherein the sleeve is rotatable by a displacement of 90 degrees or less from the secured state to the release state.

7. The bit retainer of claim 6, wherein the cap and the collet are removable from the bit retainer by further rotating the sleeve in the loosening direction beyond the release state until the rearward extension of the cap decouples from the nut.

8. The bit retainer of claim 1, wherein the collet is a standardized collet of a first geometry, and wherein the collet is interchangeable with a standardized collet of a second geometry.

9. The bit retainer of claim 1, wherein the sleeve is rotatable relative to the body about the rotational axis.

10. The bit retainer of claim 1, wherein the sleeve is slidable relative to the body along the rotational axis.

11. The bit retainer of claim 1, wherein the output spindle is an anvil configured to receive rotational impacts from a hammer of the power tool, and wherein the body is an integral portion of the output spindle.

12. The bit retainer of claim 1, wherein the body includes a plurality of slots.

13. The bit retainer of claim 1, wherein the wedge surface is formed on the sleeve.

14. A bit retainer configured to couple a tool bit to an output spindle of a power tool, the bit retainer comprising:
a body coupled for co-rotation with the output spindle about a rotational axis;
a standardized collet including a plurality of jaws positioned at least partially within the body, the standardized collet defining a bore between the plurality of jaws configured to receive the tool bit; and
a sleeve surrounding the body, wherein the sleeve is movable relative to the body to compress the plurality of jaws around the tool bit.

15. The bit retainer of claim 14, further comprising a cap coupled to the body, wherein the sleeve is rotatable to translate the cap relative to the body.

16. The bit retainer of claim 15, further comprising a nut coupled to the sleeve, wherein the cap includes a rearward extension threadably coupled to the nut such that rotation of the nut relative to the cap causes the cap to translate.

17. The bit retainer of claim 16, further comprising a ring coupled for co-rotation with the sleeve and a ratchet assembly coupled to the ring, wherein the ratchet assembly is configured to interrupt torque transmission between the ring and the nut above a predetermined torque threshold corresponding with a secured state, in which the tool bit is securely clamped between the plurality of jaws.

18. The bit retainer of claim 17, wherein the sleeve is rotatable in a loosening direction from the secured state to a release state, in which the tool bit is freely removable from the bit retainer, and wherein the sleeve is rotatable by a displacement between 30 degrees and 40 degrees from the secured state to the release state.

19. The bit retainer of claim 14, wherein the standardized collet is an ER-20 collet.

20. A power tool comprising;
a housing;
a motor supported within the housing;
an output spindle extending from the housing and driven by the motor to rotate about a rotational axis; and
a bit retainer configured to couple a tool bit to the output spindle such that the tool bit co-rotates with the output spindle about the rotational axis, the bit retainer including
a body coupled for co-rotation with the output spindle,
a collet including a plurality of jaws positioned at least partially within the body, the collet defining a bore between the plurality of jaws configured to receive the tool bit,
a wedge surface engageable with the collet, and
a sleeve surrounding the body, wherein the sleeve is movable relative to the body to engage the wedge surface against the collet and compress the plurality of jaws around the tool bit.
